(19) United States
(12) Patent Application Publication
(10) Pub. No.: US 2014/0310590 A1
(43) Pub. Date: Oct. 16, 2014

(54) PRESENTATION LAYER SOFTWARE DEVELOPMENT KIT FOR CREATION OF DYNAMIC WEBPAGES

(71) Applicants: Thong Nguyen, St. Louis, MN (US); Jay Finch, St. Paul, MN (US); Erik Mason, Burnsville, MN (US); Erik Mitchell, Minneapolis, MN (US); Cory Roloff, Roseville, MN (US)

(72) Inventors: Thong Nguyen, St. Louis, MN (US); Jay Finch, St. Paul, MN (US); Erik Mason, Burnsville, MN (US); Erik Mitchell, Minneapolis, MN (US); Cory Roloff, Roseville, MN (US)

(73) Assignee: BBY SOLUTIONS, INC., Richfield, MN (US)

(21) Appl. No.: 14/205,147

(22) Filed: Mar. 11, 2014

Related U.S. Application Data
(60) Provisional application No. 61/780,049, filed on Mar. 13, 2013.

(51) Int. Cl. G06F 17/22

(52) U.S. Cl. CPC G06F 17/2247
USPC 715/234

(57) ABSTRACT

Systems and methods for designing and implementing dynamic and template-based web page content are described herein. One example includes a presentation layer software development kit providing a full-featured graphical user interface for the design of web page components and structures. The presentation layer software development kit may integrate with various design, development, compilation, and testing tools to generate production-ready web page output in a scalable architecture. Using the presentation layer software development kit, modifications to the web page content may be generated, tested, and deployed in a real-time basis, reducing design and implementation times.

### PRIORITY APPLICATION

This application claims the benefit of priority to U.S. Provisional Patent Application Ser. No. 61/780,049, filed Mar. 13, 2013, which is incorporated herein by reference in its entirety.

### TECHNICAL FIELD

Embodiments pertain to techniques and systems for development of websites and internet-accessible graphical user interfaces. Some embodiments relate to software-based tools and architectures to design, develop, and implement dynamic and template-based web pages and content included within such web pages.

### BACKGROUND

A variety of tools are used to design and implement web pages to be hosted by web sites. Some of the most basic tools involve the design and generation of static HTML in a web page, with hard coded text and design elements programmed directly into the HTML. Other existing tools involve the design of web pages to include dynamic data, often utilizing specific server-side data calls or scripting to be added into the web page code during development. This often forces the web page developer to be proficient in both design and data access techniques.

In many scenarios, different development teams are involved with creation of a website, with one team focusing on the design elements of webpages (for example, user interface designers, graphic designers, and the like), versus another team focusing on the data elements used to serve the dynamic content in the webpages (for example, database programmers, server managers, and the like). Additionally, other parties such as quality assurance teams may wish to perform tests on the web page output to ensure accuracy and compliance in the final output website.

Changes to the layout or design of web pages often requires changes to the design, which may require rework to the data elements, which may require rework to the testing process, and so forth. Existing systems and techniques do not provide adequate mechanisms to segment the development of webpage design between HTML design elements and the back-end data, or provide useful tools to automate such processes.

### BRIEF DESCRIPTION OF THE DRAWINGS

FIG. 1 illustrates an architecture for the creation of dynamic web pages according to an example described herein.

FIG. 2 illustrates an overview of a process to utilize a presentation layer development environment for the creation of dynamic web pages according to an example described herein.

FIG. 3A illustrates a first portion of a detailed process for generating a web page in a presentation layer development environment according to an example described herein.

FIG. 3B illustrates a second portion of a detailed process for generating a web page in a presentation layer development environment according to an example described herein.

FIG. 4 illustrates a deployment of a web page developed with a presentation layer development environment according to an example described herein.

FIG. 5 illustrates a graphical user interface of a presentation layer development environment providing verification of operation requirements during software installation according to an example described herein.

FIG. 6 illustrates a graphical user interface of a presentation layer development environment providing a selection and modification of designed web pages according to an example described herein.

FIG. 7 illustrates a graphical user interface of a presentation layer development environment providing a selection and modification of a data scenario used in a web page according to an example described herein.

FIG. 8 illustrates a graphical user interface of a presentation layer development environment providing a compilation and testing of designed web pages according to an example described herein.

FIG. 9 illustrates a graphical user interface of a presentation layer development environment providing a compilation and testing of modular components for use in a designed web page according to an example described herein.

FIG. 10A illustrates a graphical user interface of a presentation layer development environment providing a selection of deployable web sites having designed web pages according to an example described herein.

FIG. 10B illustrates a graphical user interface of a presentation layer development environment providing a preview of a deployable web site having designed web pages according to an example described herein.

FIG. 11 illustrates an example method of generating a web page using a presentation layer development environment according to an example described herein.

FIG. 12 illustrates an example system configuration of a system arranged to provide and operate a presentation layer development environment according to an example described herein.

FIG. 13 illustrates an example of a computer system to implement techniques and system configurations according to an example described herein.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure illustrates various techniques and configurations to enable the development of web pages and associated web sites within a development framework having a full-featured graphical user interface (GUI). This web page development framework, further referred to herein as a “presentation layer software development kit (SDK)” enables the creation of dynamic web pages with an enhanced user experience. Such web pages may be deployed in any number of settings, but in particular can provide a scalable architecture for large websites with frequently changing content (for example, in an e-commerce web site with thousands of changing products and product information).

The presentation layer SDK may integrate a number of development and testing processes to enable a user to immediately see what he or she is building, as the respective web page components are being built. Presentation layers for the web page components may be built on top of data, but without requiring hard-coded references to such data. Such design methods enable web page components in the presentation layers to be prototyped and moved into production in a rapid fashion. These mechanisms reduce the lifecycle needed to move web pages from development into production.

The presentation layer SDK enables the creation of various presentation layers in web page components that can be added, replaced, swapped out, and copied elsewhere. The use of modular web page components with the presentation layer SDK offers a clean architectural separation to reuse components down the road, with less waste and rework. Further, the use of data references in the components enables a designer to build the user experience for the particular component, without needing to customize the data call to the uses of the component.

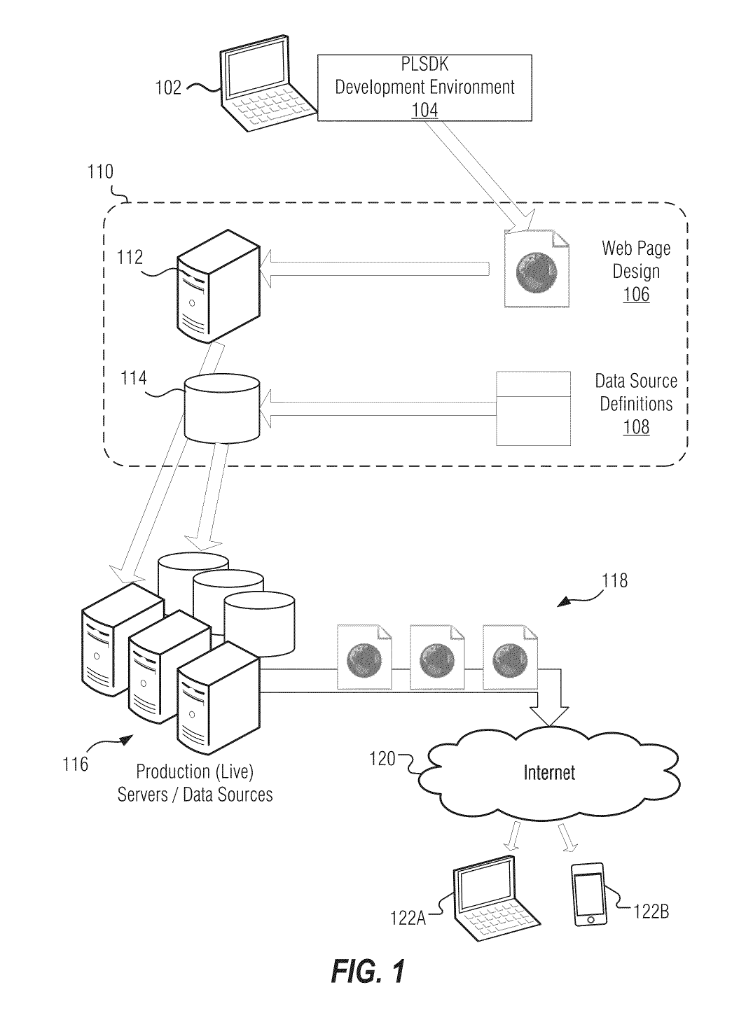

FIG. 1 illustration an overview of development and deployment of a web page with use of the presentation layer SDK according to one example. As illustrated, a computing device 102 (e.g., a PC) is used to operate the presentation layer SDK 104 development environment (e.g., a GUI and associated software applications). The presentation layer SDK 104 development environment produces a web page design 106 for use in a prototype environment 110. The prototype environment may include a web page design 106 having web pages constructed from a variety of components, for operation on a web server 112.

The web page design 106 is configured to reference various data inputs and values from a mock data source. These data values are referenced using a set of data source definitions 108. The prototype environment 110 may include a database 114 (e.g., containing mock data) to provide sample testing data for access by the data source definitions 108.

Upon adequate design and testing of the web page design 106 and the data source definitions 108 in the prototype environment 110, a web page output is provided to a set of production web servers and data sources 116. This web page output can replace references to the mock data source with a production data source. The production web servers and data sources 116 will serve to output a series of web pages 118 for delivery to client devices 122A, 122B via the internet 120. Thus, the series of web pages 118 in combination serves to offer a fully functional web site serving dynamic content to browsing users.

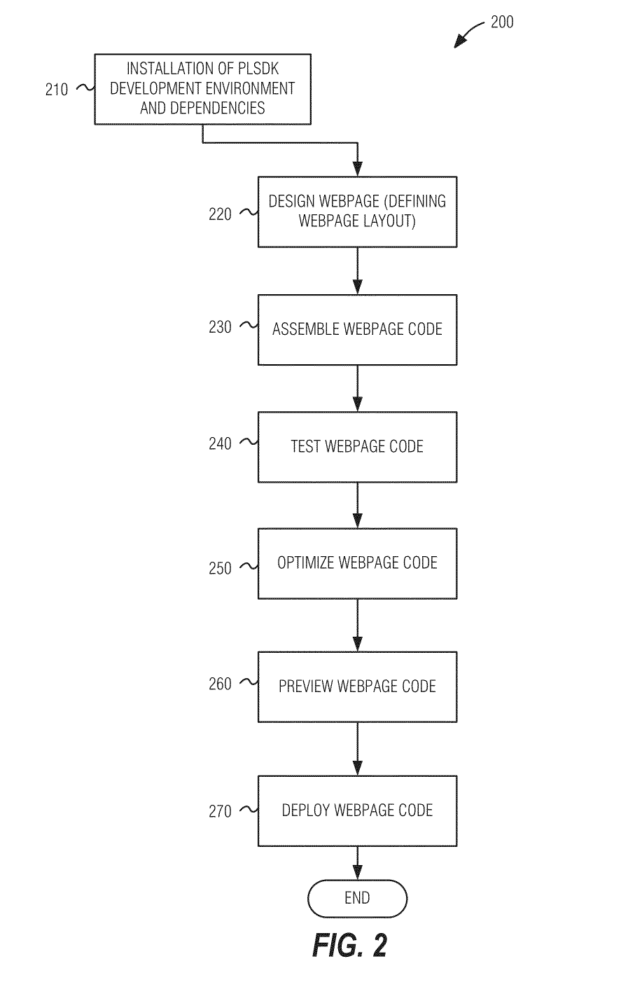

FIG. 2 depicts an overview of a process to utilize the presentation layer SDK 104 for the creation of dynamic web pages such as the web pages 118 according to an example described herein. As shown, a sequence of operations 200 is commenced from the installation of the presentation layer SDK 104 and associated dependencies (operation 210). The following sequence of operations provides an example of a web page development process using processing from the presentation layer SDK, but it will be apparent that variations to the following order of operations may be conducted.

First, a web page design is established for defining the web page layout (operation 220). The web page design may be defined through GUI interactions, manual HTML coding and editing, or a combination thereof. Next, the presentation layer SDK 104 is used to assemble web page code, such as HTML, JavaScript, other browser-renderable code (operation 230).

The presentation layer SDK 104 may also provide mechanisms to enable a user to immediately test the web page code (operation 250) and optimize the web page code (operation 260). Finally, the web page code may be deployed (operation 270) for serving to browser clients. For example, the web page code and associated static content such as images, scripts, and styles may be placed on one or more internet-accessible web page servers for hosting and access by remote users.

### Features of Presentation Layer SDK

The presentation layer SDK 104 may provide a web-based GUI, executable on various platforms (e.g., Mac OS and Windows), to integrate with a series of development components including open source components. For example, the presentation layer SDK 104 may integrate with a JavaScript runtime such as Node.js to design and serve data elements in the web page. The presentation layer SDK may also provide GUI controls to enable users to design and manipulate web page components without the use of manual coding. The presentation layer SDK 104 can provide compilation of the web page components and component outputs during the design process, on demand or automatically as changes are made.

The presentation layer SDK 104 enables the creation of data element references without requiring hard-coded references to the data in the web page components. To accomplish this, the presentation layer SDK 104 may include capabilities to test simulated data values and data references that can be defined at a later time. In addition, the presentation layer SDK includes routing capabilities to simulate server-side processing (such as AJAX requests) and thus fully render designed web page components.

The presentation layer SDK 104 can perform integrated processing operations with third party applications to facilitate deployment and usage. For example, the presentation layer SDK 104 may render a template file into HTML pages for preview capability, and render the template file against multiple JSON files to mock up server-side variations of data. Output JavaScript and style files may be converted, merged, and minified as appropriate. Other programs such as MD5 fingerprinting may be applied to rename files for server-side output.

The presentation layer SDK 104 may also enable the creation and use of a variety of site-specific templates as defaults for new pages and components. The organization and categorization of pages can be entirely customizable within the presentation layer SDK 104. The presentation layer SDK 104 may be used to edit multiple web sites or web site scenarios, providing environments for both debug and release mode outputs. Output files and scripting, styles, and HTML output may also be analyzed, tested, and validated.

### Example Web Page Creation Process

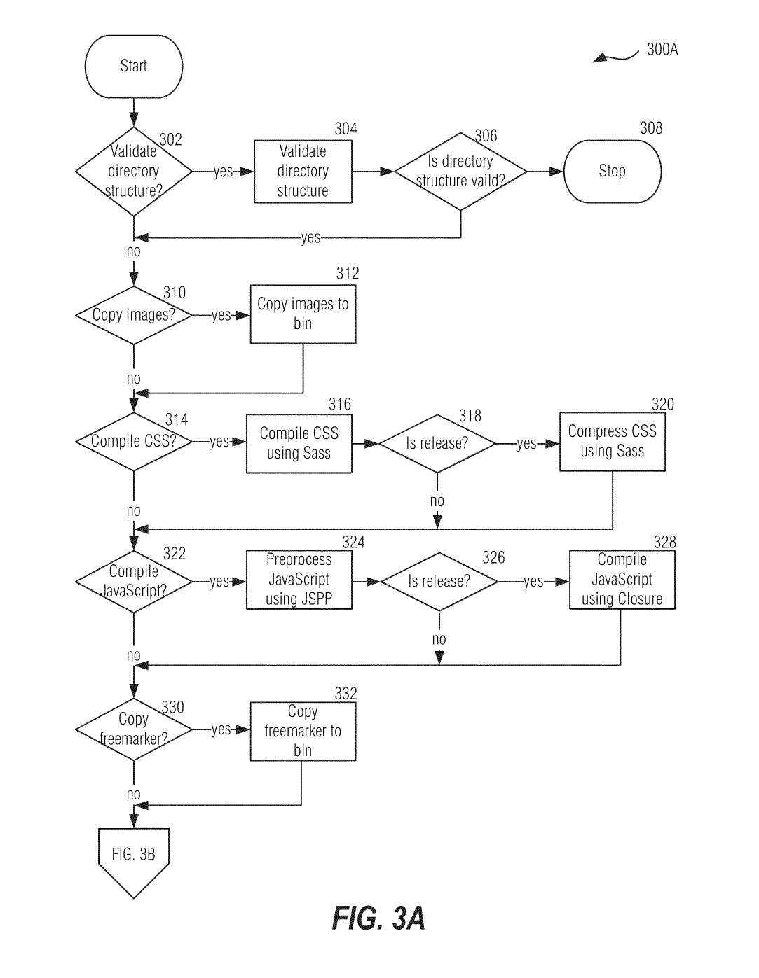

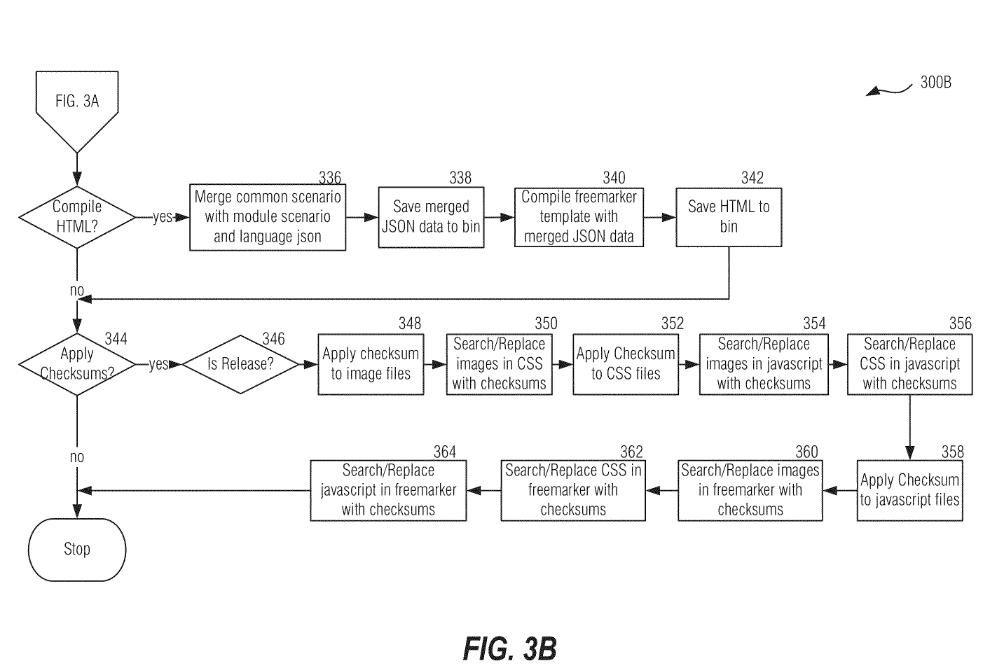

The presentation layer SDK may perform a multi-step verification and compilation when generating a web page and associated web page components. FIG. 3A illustrates a first portion of a detailed process 300A for generating a web page in a presentation layer development environment according to an example described herein.

As shown, the process 300A includes a series of operations performed in response to determining that a directory structure for a web site project is to be validated (decision 302). These operations include validating the directory structure (operation 304), and proceeding if the directory structure is valid (decision 306). If the directory structure is not valid, the process 300A terminates (operation 308).

Next, the process 300A includes an operation to copy images to a bin or other destination folder (operation 312) in response to determining that images are available to be copied (decision 310). These images and other associated files are placed in a destination folder for deployment on the web site.

Next, the process 300A includes operations to compile a cascading style sheet (CSS) file performed in response to determining that a CSS file is available to be compiled (decision 314). These operations include compiling the CSS file using Sass (operation 316). If the CSS file is designated for release (determined by decision 318), the CSS file for release is compressed using Sass (operation 320).

Next, the process 300A includes operations to compile a JavaScript file performed in response to determining that a JavaScript file is available to be compiled (decision 322). These operations include preprocessing the JavaScript file using the JSPP scripting language (operation 324). If the JavaScript file is designated for release (determined by decision 326), the JavaScript file for release is compressed using Closure (operation 328).

Next, the process 300A includes operations to copy a FreeMarker compilation in response to determining that a FreeMarker compilation file is available to be copied (decision 330). The FreeMarker compilation file provides a template-based form of the web page, used to deploy the design of the web site and associated Java objects into output (after running through the FreeMarker template engine). Other template-based compilations may also be used or substituted for the usage of FreeMarker.

The process 300B, illustrated on FIG. 3B, continues the series of operations. These include operations to compile HTML output performed in response to an instruction that the HTML output is available to be compiled (decision 334). The operations include merging a common scenario with a module scenario and language JSON (operation 336), saving the merged JSON data to the bin folder (operation 338), compiling a FreeMarker template with the merged JSON data (operation 340), and saving the HTML to the bin folder (operation 342).

Next, the process includes operations to apply checksums to the various files, to genericize and rename the file names, in response to determining that the files are available to have checksums applied (decision 344) and that the output is designated for release (decision 346). If the output is designated for release, further operations include applying the checksum to the image files (operation 348), search and replacing images in the CSS files with checksums (operation 350), applying the checksum to the CSS files (operation 352), searching and replacing images in the JavaScript files with checksums (operation 354), searching and replacing CSS in the JavaScript files with checksums (operation 356), applying the checksum to the JavaScript files (operation 358), searching and replacing image references in the FreeMarker template file with checksums (operation 360), searching and replacing CSS references in the Freemarker template file with checksums (operation 362), and searching and replacing JavaScript references in the Freemarker template with checksums (operation 364).

### Example Web Page Creation and Generation Process

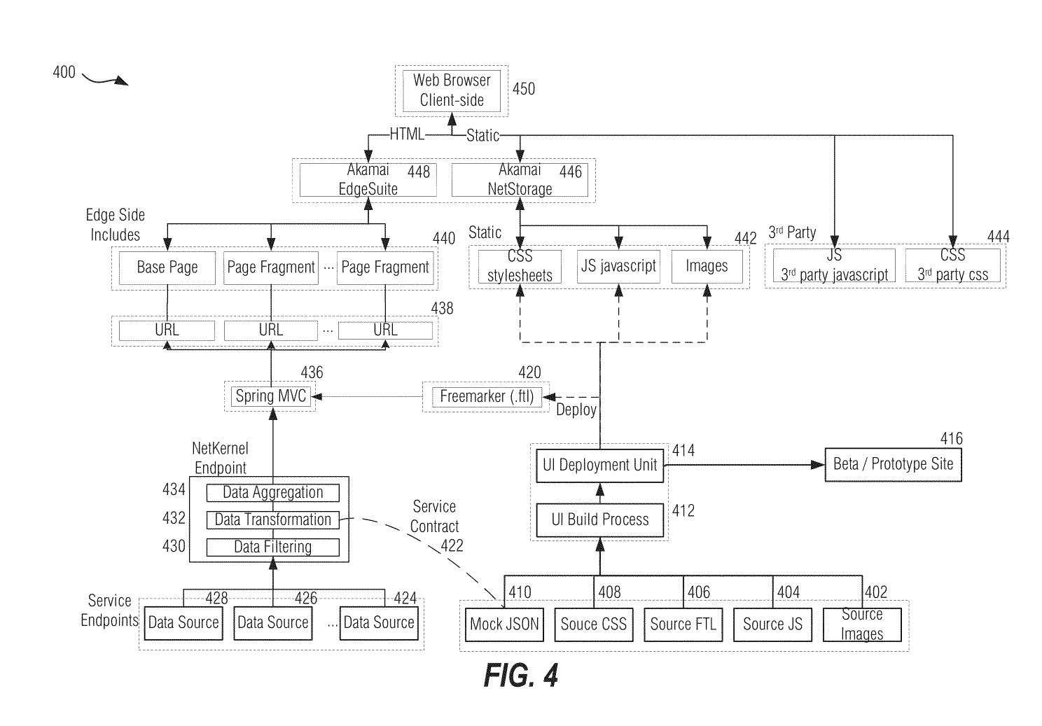

FIG. 4 provides an overview of server-side data operations 400 for delivering a web page output to a client-side user, such as at a web browser 450. Operations involving the presentation layer SDK 104 are utilized during the user interface build process 412 and with a user interface deployment unit 414. The input to the user interface build process 412, compiled by the presentation layer SDK 104, includes one or more source images 402, one or more source JavaScript files 404, one or more source FreeMarker .FTL template files 406, one or more source CSS files 408, and one or more mock JSON files 410. The presentation layer SDK 104 utilizes the user interface deployment unit 414 to generate a beta or prototype site 416. (This beta or prototype site can be used for a variety of mockup, testing, and development operations).

The output of the presentation layer SDK 104 is used to provide a rendering template 420, for example, in the Freemarker .FTL format. This is provided to a Spring Web model-view-controller (Spring MVC) 436 application to produce HTML output. The HTML output provides a correct integration of the data values produced from production data sources.

The data values are established from various data sources 424, 426, 428, through data filtering 430, data transformation 432, and data aggregation 434 operations. The data is referenced through use of a service contract 422 between the mock JSON files 410 and the data sources. For example, the mock JSON will designate references to data values that are used at different locations in the web page components. A database developer may take these references to produce values from the production data sources. Thus, the mock JSON data is used because the actual data calls from the production databases are not established until runtime.

The output from the Spring MVC 436 is to create various components at respective URLs 438 which make up components for inclusion at the server, including a base page and page fragments 440. The base page and page fragments at this point include the HTML output with integrated data values, essentially the HTML output for serving by the web server. Accordingly, this HTML output is served by a web server 448.

The other elements of the webpage, including CSS files, JavaScript files, and images 442, designated from an output of the user interface deployment unit 414, are also provided from a web server 446.

Thus, the web browser 450 is provided with content from a variety of sources: the HTML content from web server 448, graphical/scripting/design files from web server 446, and third party content such as third party JavaScript and CSS files from other web servers 444.

### Example Operations of Presentation Layer SDK

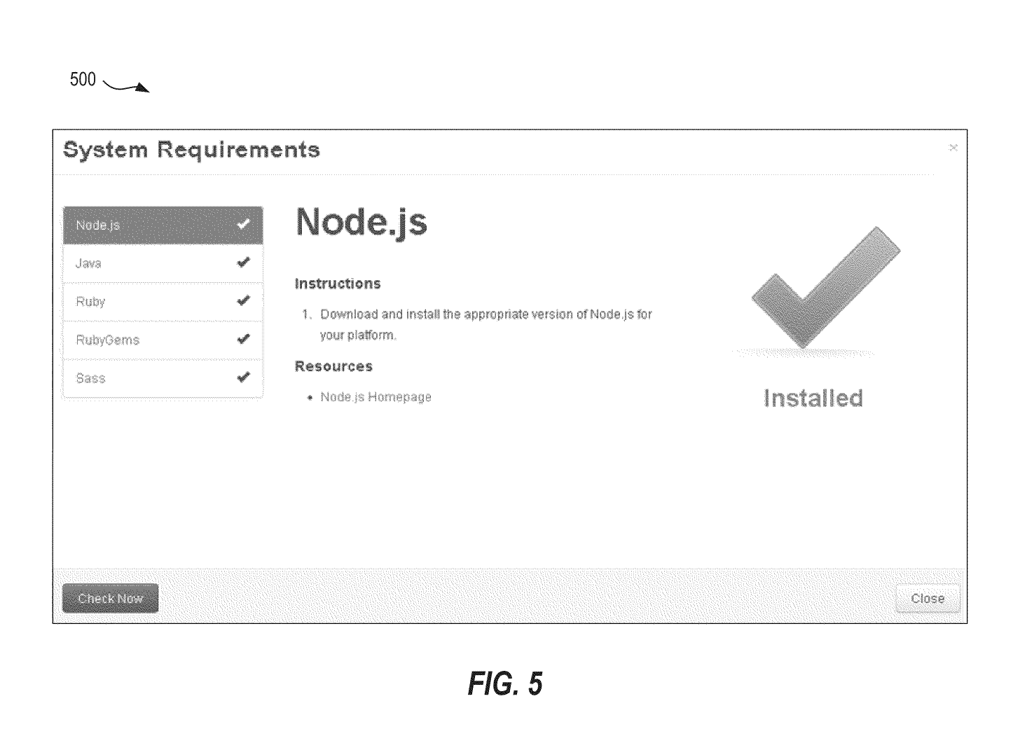

FIG. 5 illustrates a graphical user interface 500 of a presentation layer development environment providing verification of operation requirements during software installation according to an example described herein. As shown in the graphical user interface 500, the presentation layer SDK may run a series of verifications to ensure installation or access to components. In one example, these components may include, but are not limited to, Node.js, Java, Ruby, RubyGems, and Sass.

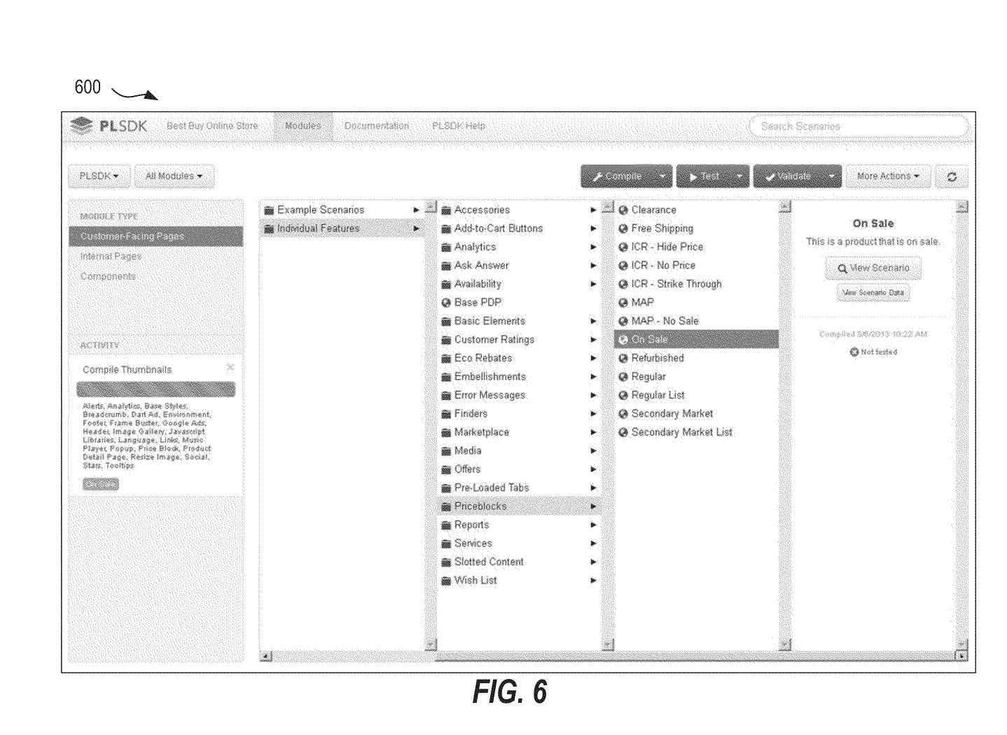

FIG. 6 illustrates a graphical user interface 600 of a presentation layer development environment providing a selection and modification of designed web pages according to an example described herein. The graphical user interface 600 includes a listing of various web pages and web page components, including changeable and substitutable content. For example, pricing content for an e-commerce website may take one of many forms, based on changing data values. The graphical user interface 600 may provide the ability to view and render a particular web page component to visualize the use of the specific pricing content as provided by respective pricing components.

Options for development in the graphical user interface 600 include options to “Compile”, “Test”, “Validate”, and the like. In some examples, the presentation layer development key may be configured to rebuild an HTML output (or an HTML preview) in real time as the file is changed. Further, through compilation, testing, and validation, respective components for web pages can be changed and previewed in real time. The compile process for HTML pages may include performance of optimization, error checking, and verification for errors (such as JavaScript errors). Technical optimizations, minifications, and tweaks can all be applied to the web page output to make the web page production ready. Further, the compilation, testing, and validation process can enforce quality standards for a particular web site, even while prototyping.

In the graphical user interface 600, sample data elements may be used and defined by the presentation layer development environment. The correct data elements from production data sources may be obtained at a later time, with values such as names, prices, and other dynamic content being simulated during development of the web page components. Thus, the graphical user interface 600 can provide a replicated presentation of data and end-customer experience, relying on data aggregator definitions to tie the correct data to the components.

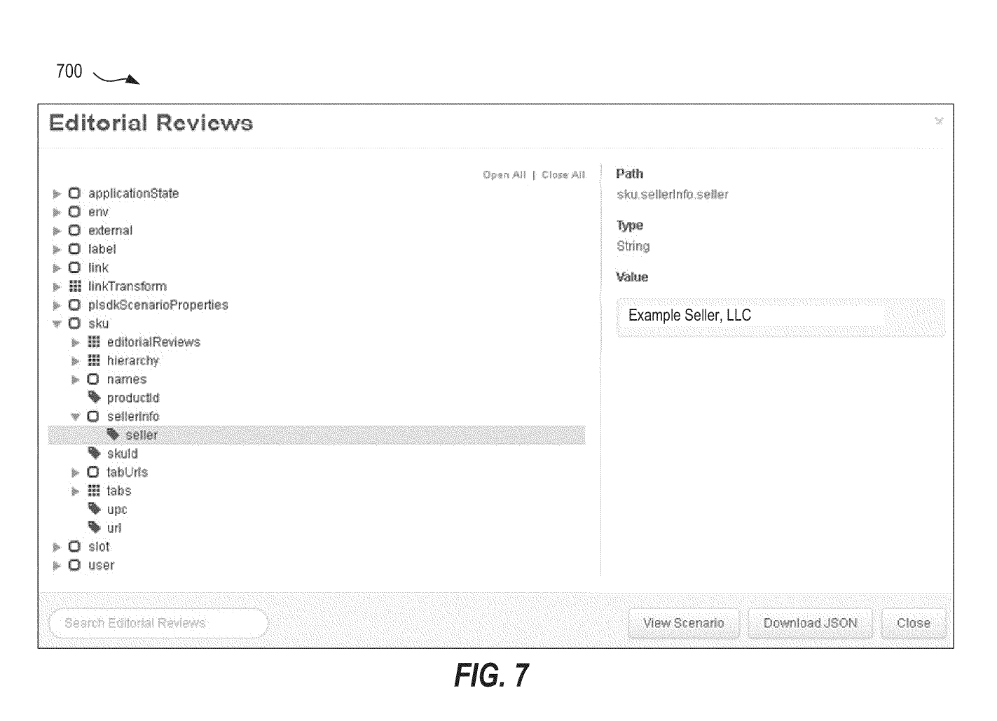

FIG. 7 illustrates a graphical user interface 700 of a presentation layer development environment providing a selection and modification of a data scenario used in a web page according to an example described herein. The data scenario illustrated, here titled “Editorial Reviews”, serves as a data structure having a variety of data types and data values. Such data scenarios are created through use of a data contract accessible by the presentation layer development environment, which ensures that the web page should look as it is supposed to when the actual data set is generated. The presentation layer development environment enables a developer to redo and change the format of presentation, as long as references to the data scenario remain the same.

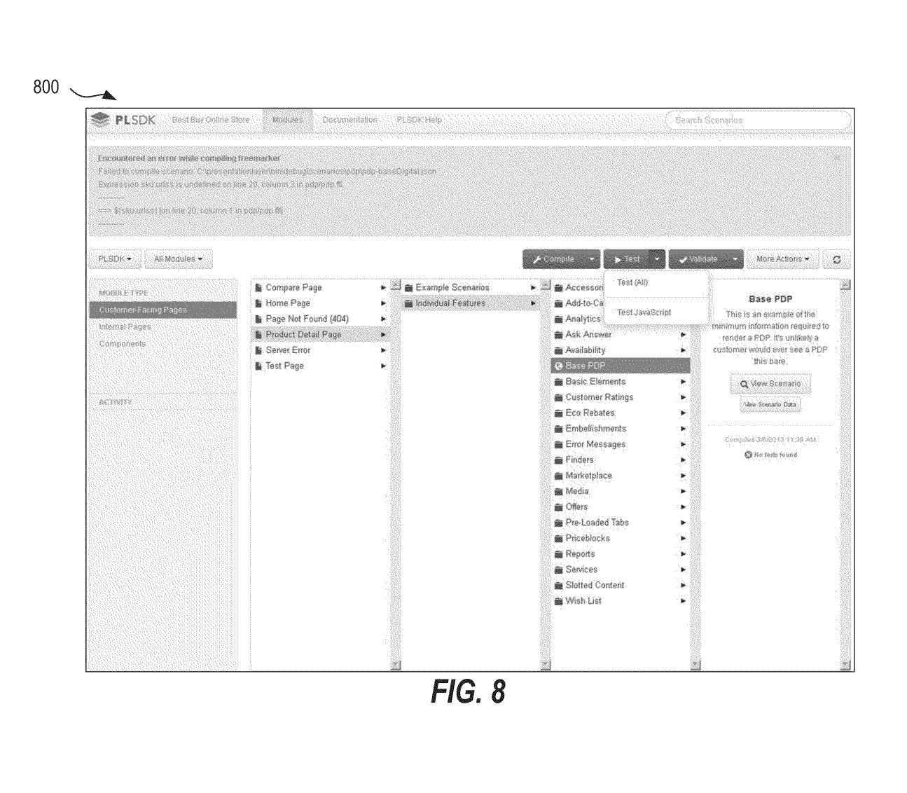

FIG. 8 illustrates a graphical user interface 800 of a presentation layer development environment providing a compilation and testing of designed web pages according to an example described herein. As shown in the graphical user interface 800, a particular expression is undefined and has encountered an error. Further mechanisms to interact with test scripts and testing methods may be accessed through the graphical user interface 800.

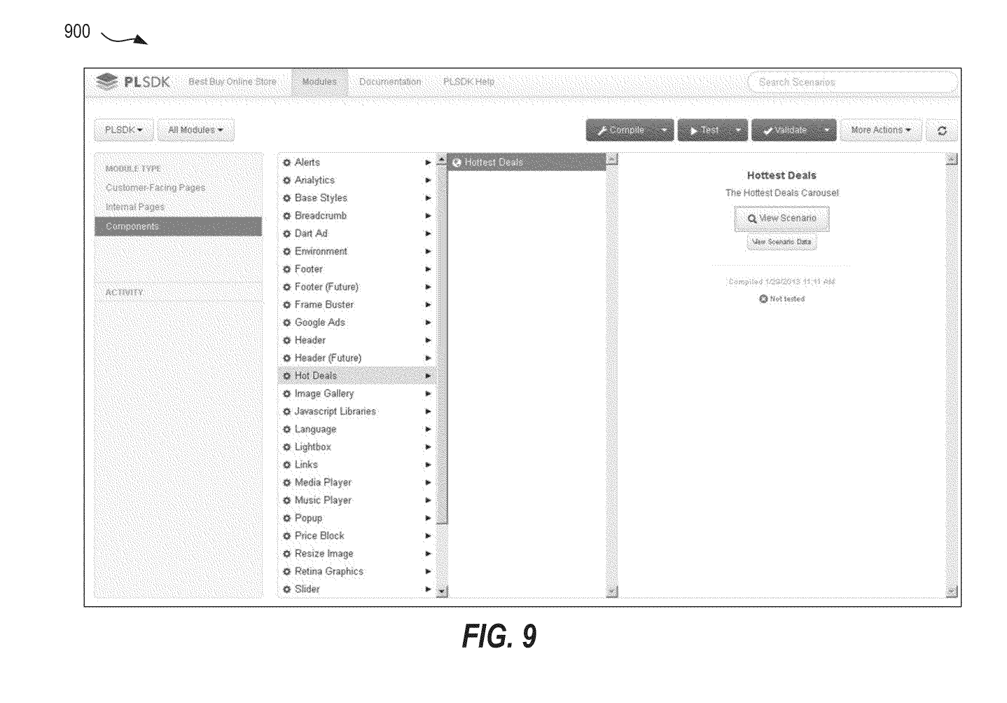

FIG. 9 illustrates a graphical user interface 900 of a presentation layer development environment providing another view for compilation and testing of modular components for use in a designed web page according to an example described herein. The graphical user interface 900 may provide a mechanism to view the web page component with a selected data scenario. Additionally, the graphical user interface 900 may provide an indication of compilation and testing.

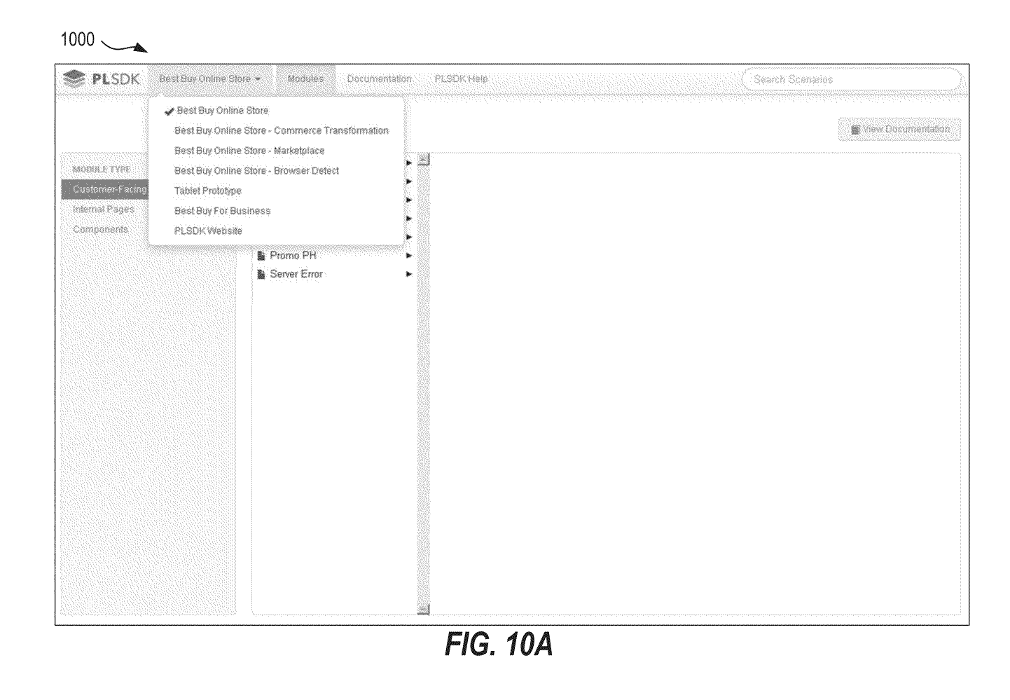

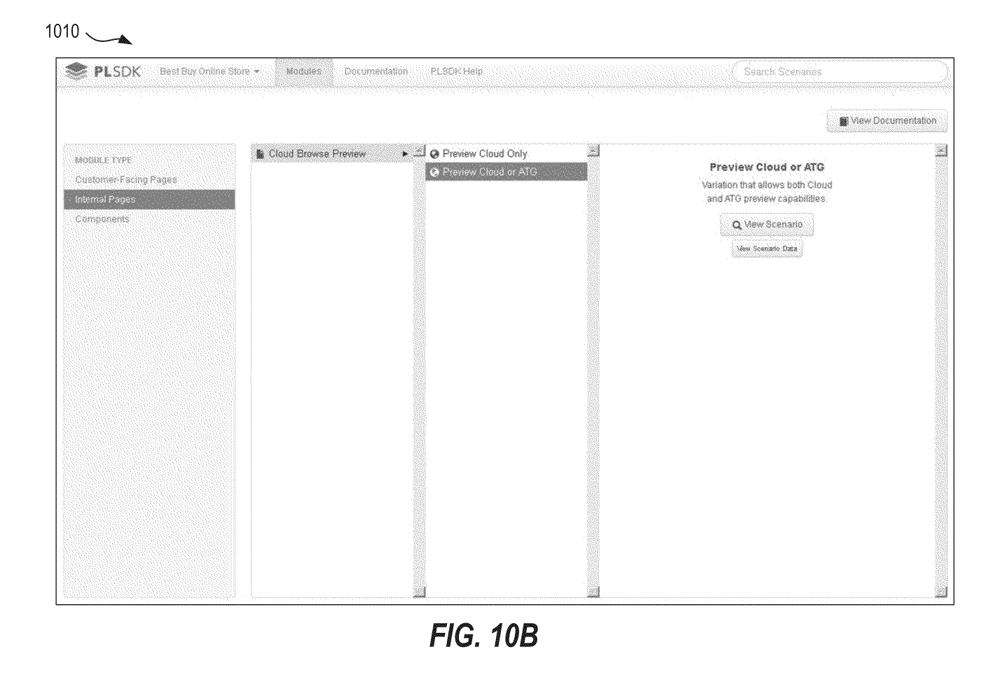

FIG. 10A illustrates a graphical user interface 1000 of a presentation layer development environment providing a selection of deployable web sites having designed web pages according to an example described herein. As shown in graphical user interface 1000, a variety of web site deployments may be selected from a pull-down menu. FIG. 10B illustrates a graphical user interface 1010 of a presentation layer development environment providing a preview of a deployable web site having designed web pages according to an example described herein. Not are individual components testable, but externally-visible and internally-visible pages may also be generated with use of the presentation layer development environment.

### Example Uses of Presentation Layer SDK

Configuration properties may be used in a presentation layer development environment according to an example described herein. Configuration properties and values may be used to define various values for a web site project in the presentation layer SDK. The presentation layer SDK can be used to maintain any number of web site projects. Each web site project can be individually configured to have unique details, configuration, deployment scripts, and help files. Thus, various options such as an identifier, name, version, source control branch, validation options, execution options, third party control options, and the like may be designated for each site designed by the presentation layer SDK.

A site structure may also be used in a presentation layer development environment according to an example described herein. A variety of uses of various third party components and data inputs may be used in the presentation layer SDK. Various folders and folder descriptions may be provided for use with the presentation layer SDK. The folders used by the presentation layer SDK may include: locations for inputs; locations of components, templates, images, scripts, style sheets, and the like; locations for tests; and locations for help files.

Modules and module properties may also be used in a presentation layer development environment according to an example described herein. Modules are self-contained development elements that have individual HTML output, scripting, styles, and the like, which are used to provide a web page, component within a web page, or other display elements. A designation of a module and associated module properties may be provided, such as an identifier, display name, type, dependencies, help documentation, and the like.

Routes and route properties may also be used in a presentation layer development environment according to an example described herein. A route provides a mechanism to intercept requests and assisting data elements such as pages, images, scripts, and the like from a site's compiled artifacts. A designation of a route and associated route properties may be provided, such as a route array designating a method type, requests, responses, and any delay.

Website templates and website template properties may also be used in a presentation layer development environment according to an example described herein. A website template serves as a file and folder structure, and allows a web page to be created from a starting point with common content such as a standard header or footer. A designation of a template folder structure, and a designation of properties for files such as template, scripting, and style files, may be provided.

### Computing System Architectures and Example Implementations

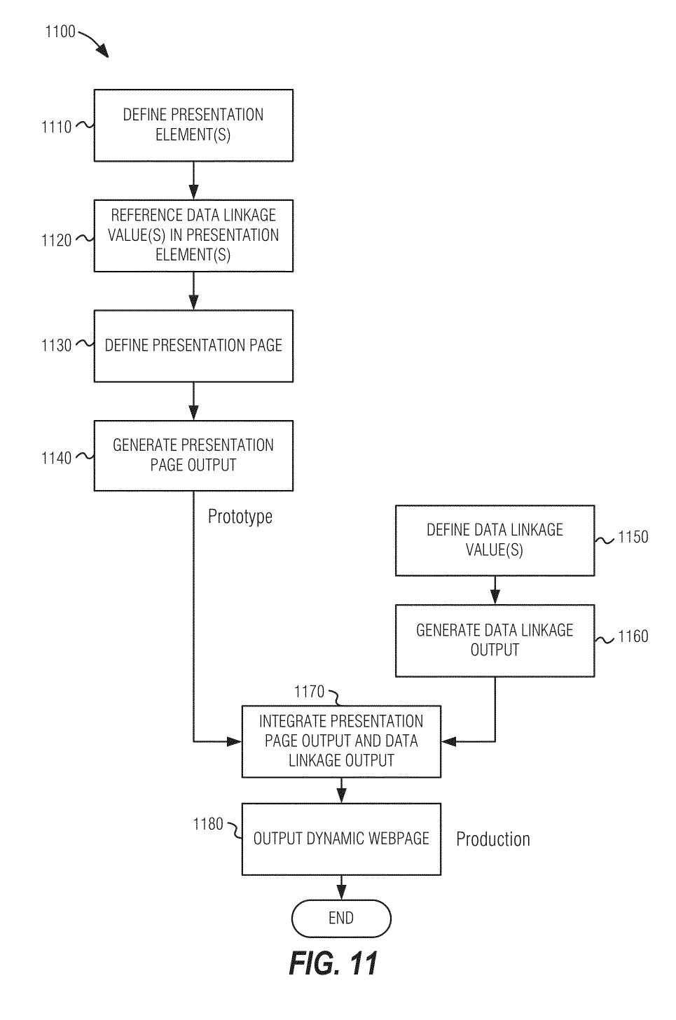

FIG. 11 illustrates a flowchart 1100 of an example workflow for generating a dynamic web page using the development framework and the presentation layer SDK 104 according to an example described herein. The particular sequence depicted in the flowchart 1100 is provided as a non-limiting example, and illustrates a workflow involving the separate definition of presentation elements and data elements. It will be apparent that the order of development and integration with data elements may vary depending on the particular application, development lifecycle, and development scenario. In addition, other aspects of the workflow not illustrated may include additional interactions with information systems and associated graphical user interfaces.

The flowchart 1100 illustrates a series of operations executable with the presentation layer SDK 104, including the definition of presentation elements (operation 1110) and the creation of references to data linkage values in the presentation elements (operation 1120). The references to the data linkage values are used to define a presentation page (operation 1130), from which the presentation page output may be generated (operation 1140). During a prototype of the page, the data linkage values may be linked to dummy or test variables.

In parallel or separately, the actual data linkage values may be designated and integrated for use with the web page. This may include the definition of data linkage values (operation 1150) to replace the dummy or test variables used in the prototype page. This may also include a generation of a data linkage output (operation 1160) using the presentation layer SDK 104 or other tools.

The presentation page output and the data linkage output is then integrated for serving from a website (operation 1170) such as from use of one or multiple web servers. From this integration on one or multiple web servers, an output of the dynamic web page content may be provided to client users (operation 1180).

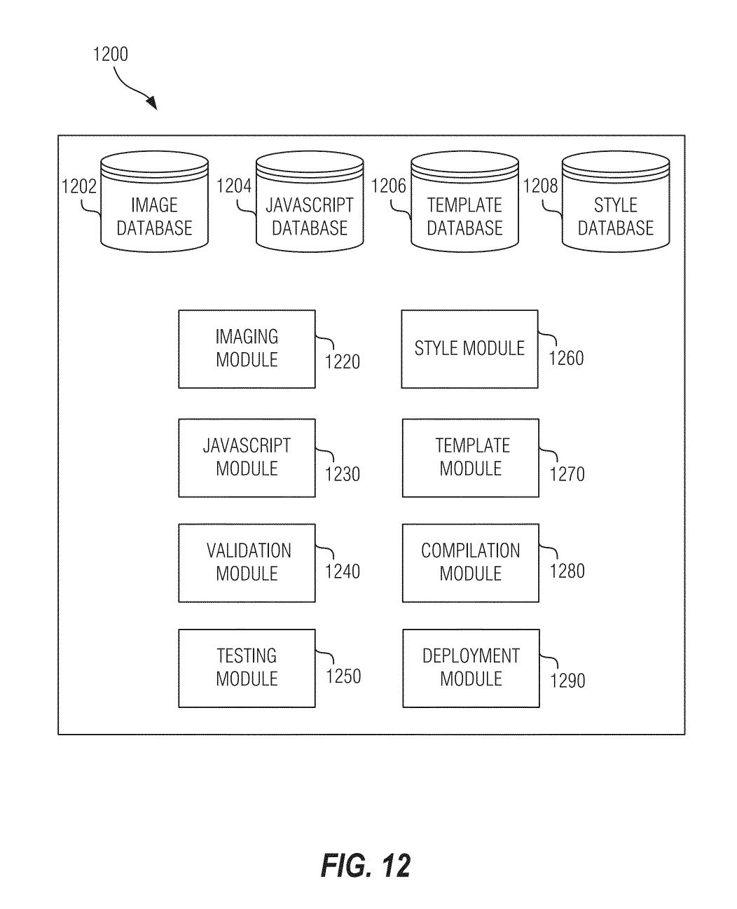

FIG. 12 illustrates an example configuration of a system architecture 1200 configured to implement the presently described presentation layer SDK and accompanying development framework. The system architecture 1200 may include an image database 1202, a JavaScript database 1204, a template database 1206, and a style database 1208. Functional modules operating in the system architecture 1200 may include an imaging module 1220, a JavaScript module 1230, a validation module 1240, a testing module 1250, a style module 1260, a template module 1270, a compilation module 1280, and a deployment module 1290.

The image database 1202 may provide a location for storage of images used in connection with the operations of the presentation layer development environment. The JavaScript database 1204 may provide a location for storage of JavaScript files and related scripts used in connection with the operations of the presentation layer development environment. The template database 1206 may provide a location for storage of template files (e.g., FreeMarker files) and related template information used in connection with the operations of the presentation layer development environment. The style database 1208 may provide a location for storage of styles (e.g., CSS files) and related style information used in connection with the operations of the presentation layer development environment.

The respective modules facilitate operations for developing web pages in the presentation layer development environment. For example, the imaging module 1220 may be used in connection with the image database 1202 to generate and modify images and image usage in the web page projects. The JavaScript module 1230 may be used in connection with the JavaScript database 1204 to generate and modify JavaScript and scripting usage in the web page projects. The style module 1260 may be used in connection with the style database 1208 to generate and modify cascading style sheets and other styles used in the web page projects. The template module 1270 may be used in connection with the template database 1206 to generate and modify templates and template output (e.g., FreeMarker template files) produced from the web page projects.

The other respective modules facilitate development operations in the presentation layer development environment. The validation module 1240 may be used to perform validation of scripting and code syntax, and compliance with defined standards. The testing module 1250 may be used to test compliance with test scripts and output scenarios during or subsequent to validation of the scripting and code. The compilation module 1280 may be used to generate compilation of web pages and associated scripts and scripting languages. The deployment module 1290 may be used to generate a deployable version of the various image, scripting, template, and style files.

Although some of the previous examples were provided with reference to specific website applications (such as an e-commerce website), it will be understood that the applicability of the present system and methods may apply to a variety web sites and web application settings. Further, while the preceding examples provided reference to specific web-based presentation elements such as HTML code, JavaScript, and cascading style sheets, it will be apparent that the development techniques are also applicable to other presentation development environments and settings, including the development of software applications, mobile device interfaces, and the like. Further, other development and scripting languages other than HTML, JavaScript, and CSS may be used to implement the techniques and configurations described herein.

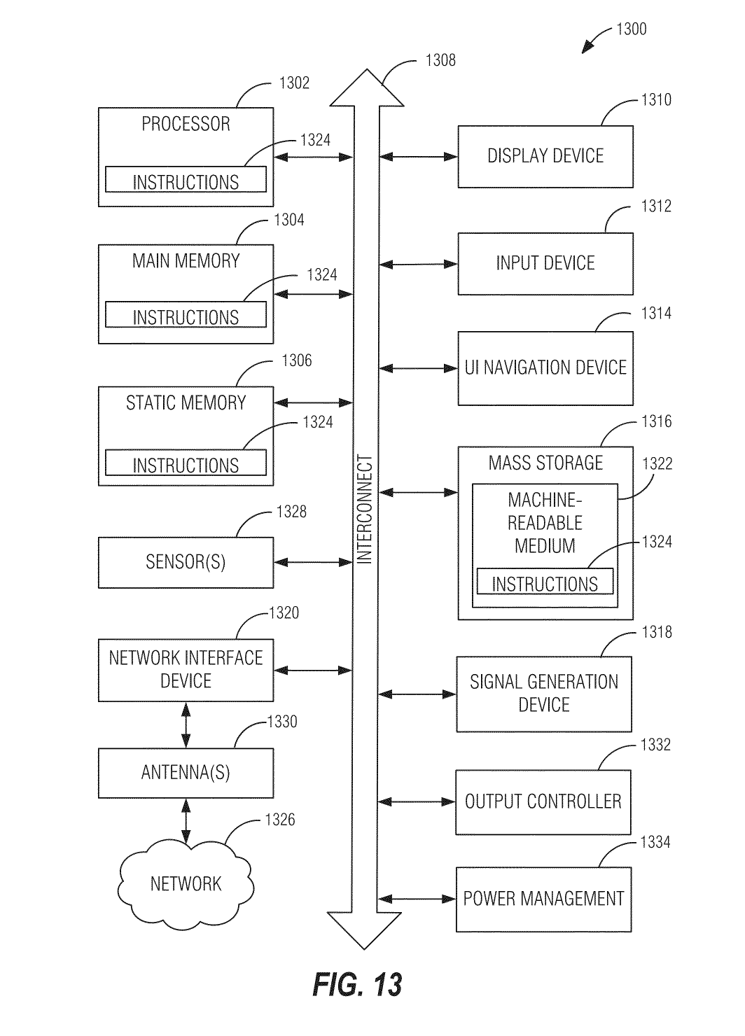

FIG. 13 is a block diagram illustrating an example computer system machine upon which any one or more of the methodologies herein discussed may be run. Computer system 1300 may be embodied as a computing device, providing operations of the components featured in FIG. 1, including the presentation layer software development kit 104 and the associated computing device 102, the prototype environment 110, the production web servers and data sources 116, the client devices 122A, 122B, or any other processing or computing platform or component described or referred to herein. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The computer system machine may be a personal computer (PC) that may or may not be portable (e.g., a notebook or a netbook), a tablet, a set-top box (STB), a gaming console, a Personal Digital Assistant (PDA), a mobile telephone or smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1300 includes a processor 1302 (e.g., a central processing unit (CPU), a graphics processing unit (GPU) or both), a main memory 1304 and a static memory 1306, which communicate with each other via an interconnect 1308 (e.g., a link, a bus, etc.). The computer system 1300 may further include a video display unit 1310, an alphanumeric input device 1312 (e.g., a keyboard), and a user interface (UI) navigation device 1314 (e.g., a mouse). In one embodiment, the video display unit 1310, input device 1312 and UI navigation device 1314 are a touch screen display. The computer system 1300 may additionally include a storage device 1316 (e.g., a drive unit), a signal generation device 1318 (e.g., a speaker), an output controller 1332, a power management controller 1334, and a network interface device 1320 (which may include or operably communicate with one or more antennas 1330, transceivers, or other wireless communications hardware), and one or more sensors 1328, such as a GPS sensor, compass, location sensor, accelerometer, or other sensor.

The storage device 1316 includes a machine-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304, static memory 1306, and/or within the processor 1302 during execution thereof by the computer system 1300, with the main memory 1304, static memory 1306, and the processor 1302 also constituting machine-readable media.

While the machine-readable medium 1322 is illustrated in an example embodiment to be a single medium, the term “machine-readable medium” may include a single medium or multiple media (e.g., a centralized or distributed database, and/or associated caches and servers) that store the one or more instructions 1324. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 1324 may further be transmitted or received over a communications network 1326 using a transmission medium via the network interface device 1320 utilizing any one of a number of well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the presentation layer SDK 104 may be client-operated software or be embodied on a server running an operating system with software running thereon. While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Additional examples of the presently described method, system, and device embodiments include the following, non-limiting configurations. Each of the following non-limiting examples can stand on its own, or can be combined in any permutation or combination with any one or more of the other examples provided below, in the claims, or elsewhere in the present disclosure.

A first example can include the subject matter (such as an apparatus, a method, a means for performing acts, or a machine readable medium including instructions that, when performed by the machine, that can cause the machine to perform acts), for defining web page development with a presentation development system, including: defining, in the presentation development system, presentation elements of a web page; referencing data values in the presentation elements of the web page; defining the presentation elements of the web page in a template; and generating a web page output for serving by a web server using the template.

A second example can include, or can optionally be combined with the subject matter of the first example, to include subject matter (such as an apparatus, a method, a means for performing acts, or a machine readable medium including instructions that, when performed by the machine, that can cause the machine to perform acts), for a web page development system, including: a processor and a memory; a validation module executing with operations of the processor and the memory and configured to validate code of a designed web page, the web page including a plurality of designed web page components; a compilation module executing with operations of the processor and the memory and configured to generate compilation of the web page and scripts associated with the web page; a testing module executing with operations of the processor and the memory and configured to test the web page and the scripts associated with the web page for compliance with one or more tests; and a deployment module executing with operations of the processor and the memory and configured to deploy the web page with a template-based output.

A third example can include, or can optionally be combined with the subject matter of one or any combination of the first and second example, to include subject matter (such as an apparatus, a method, a means for performing acts, or a machine readable medium including instructions that, when performed by the machine, that can cause the machine to perform acts), for operations to: display a graphical user interface for defining a layout of a web page; assemble web page code for the layout of the web page; test the web page code; optimize the web page code; preview the web page code; and deploy the web page code as a template.

The following claims are hereby incorporated into the detailed description, with each claim and identified combination of claims standing on its own as a separate example.

What is claimed is:

1. A method for web page development with a presentation development system, comprising:
defining, in the presentation development system, presentation elements of a web page;
referencing data values in the presentation elements of the web page;
defining the presentation elements of the web page in a template; and
generating a web page output for serving by a web server using the template.

2. The method of claim 1, further comprising:
integrating the web page output with data linkage output; and
outputting a presentation web page from the web server, the presentation web page including data values from the data linkage output integrated in the web page output.

3. The method of claim 1, further comprising:
testing, validating, and compiling the web page output.

4. The method of claim 1, wherein the web page output is provided for display in a web browser.

5. The method of claim 1, wherein the web page output is provided for display in a software application of a mobile device.

6. A web page development system, comprising:
a processor and a memory;
a validation module executing with operations of the processor and the memory and configured to validate code of a designed web page, the web page including a plurality of designed web page components;
a compilation module executing with operations of the processor and the memory and configured to generate compilation of the web page and scripts associated with the web page;
a testing module executing with operations of the processor and the memory and configured to test the web page and the scripts associated with the web page for compliance with one or more tests; and
a deployment module executing with operations of the processor and the memory and configured to deploy the web page with a template-based output.

7. The web page development system of claim 6, further comprising:
an imaging module executing with operations of the processor and memory and configured to implement one or more images used in the web page;
a JavaScript module executing with operations of the processor and the memory and configured to implement one or more JavaScript scripts used in the web page;
a style module executing with operations of the processor and the memory and configured to implement one or more styles used in the web page; and
a template module executing with operations of the processor and the memory and configured to implement one or more templates used in the web page.

8. The web page development system of claim 7, further comprising:
an image database configured to provide storage of the one or more images used in the web page;
a JavaScript database configured to provide storage of the one or more scripts used in the web page;
a template database configured to provide storage of the one or more templates used in the web page; and
a style database configured to provide storage of the one or more styles used in the web page.

9. A machine-readable storage medium comprising a plurality of instructions that, in response to being executed on a computing device, cause the computing device to:
display a graphical user interface for defining a layout of a web page;
assemble web page code for the layout of the web page;
test the web page code;
optimize the web page code;
preview the web page code; and
deploy the web page code as a template.

10. The machine-readable storage medium of claim 9, wherein the template provides information to generate HTML output of a web page on a web server, and wherein the template provides reference to one or more data objects with values of the one or more data objects included in the HTML, the values of the one or more data objects placed in the web page during generation of the HTML output of the web page.
